(19) United States
(12) Patent Application Publication
(10) Pub. No.: US 2017/0026426 A1
(43) Pub. Date: Jan. 26, 2017

(54) CALL HOLD METHOD AND TERMINAL

(71) Applicant: Huawei Technologies Co., Ltd., Shenzhen (CN)

(72) Inventors: Weiwei Chong, Shanghai (CN); Xiaobo Wu, Shanghai (CN)

(21) Appl. No.: 15/288,444

(22) Filed: Oct. 7, 2016

Related U.S. Application Data
(63) Continuation of application No. PCT/CN2014/074893, filed on Apr. 8, 2014.

(51) Int. Cl. H04L 29/06; H04M 7/00; H04W 36/14

(52) U.S. Cl. CPC H04L 65/1096; H04L 65/1016; H04W 36/14; H04M 7/006; H04W 84/042

(57) ABSTRACT

Embodiments of the present invention provide a call hold method and a terminal. The method includes: when an originating call of a terminal triggers a CS voice service, sending first indication information to an IMS sublayer by using a CC sublayer, so that the IMS sublayer detects whether an IMS voice session exists; sending signaling to a network if the IMS voice session exists, where the signaling is used to trigger a hold procedure of the INS voice session, so that the IMS voice session is in a hold state; and after the terminal completes establishment of a mobility management connection, establishing, according to second indication information, a second CS session corresponding to the IMS voice session, where the second CS session is in a hold state, thereby avoiding a case of session abnormality.

### CROSS-REFERENCE TO RELATED APPLICATIONS

This application is a continuation of International Application No. PCT/CN2014/074893, filed on Apr. 8, 2014, the disclosure of which is hereby incorporated by reference in its entirety.

### TECHNICAL FIELD

Embodiments of the present invention relate to the communications technologies, and in particular, to a call hold method and a terminal.

### BACKGROUND

In a current communications network, a Long Term Evolution (LTE) network coexists with a second generation (2G) network or a third generation (3G) network. A circuit switched fallback (CSFB) refers to that user equipment (UE) within coverage of the LTE network falls back, when processing a voice service, to a network having a circuit switched (CS) domain, and then processes the voice service in the network having the CS domain.

Single radio voice call continuity (SRVCC) refers to that in a process of making, in the LTE network, an IP multimedia subsystem (IMS) Voice over Internet Protocol (VoIP) voice call, the UE moves to an area in which an LTE network signal is relatively poor, but a 2G/3G network signal is relatively good. To ensure voice call continuity (VCC), a voice channel needs to be switched from the LTE network to the 2G/3G network. However, because carrying mechanisms of the LTE network and the 2G/3G network are different, when the UE is handed over from a PS domain to the CS domain, interruption of the voice call may occur, thereby affecting continuity of the voice call of the UE.

If a CSFB voice service, for example, an emergency call, is triggered when the UE performs an IMS VoIP service, and the LTE network does not support an emergency call service, the UE needs to be handed over to a CS domain of the 2G/3G network by means of the CSFB, to initiate a CS voice service for the emergency call service. The original IMS VoIP service needs to be switched to the voice service of the CS domain of the 2G/3G network by using an SRVCC technology.

In the prior art, after the CSFB voice service is triggered, a call control (CC) sublayer in the UE establishes a CS session for or allocates a CS session to a new CS voice service, and initiates a mobility management connection to a mobility management (MM) sublayer. After receiving a mobility management connection request, the MM sublayer triggers a CSFB procedure to an evolved packet system mobility management (EMM) sublayer, and further triggers an SRVCC procedure, so as to complete establishment of the mobility management connection. The MM sublayer sends indication information to the CC sublayer, to instruct the CC sublayer to establish a corresponding CS session for the original IMS VoIP service on which SRVCC switching is performed, and set a status of the CS session to a state corresponding to an INS VoIP session before the SRVCC switching. After the foregoing procedure, two CS sessions exist together in the UE. If the state, which corresponds to the original INS VoIP service, of the CS session is not a hold state, a case of session abnormality will occur.

### SUMMARY

Embodiments of the present invention provide a call hold method and user equipment, so as to resolve a problem of session abnormality caused by initiation of a CSFB voice service by UE that is performing an IMS VoIP service.

According to a first aspect, an embodiment of the present invention provides a call hold method, including:
sending, by a call control (CC) sublayer in user equipment (UE), first indication information to an internet protocol IP multimedia subsystem (IMS) sublayer in the UE, so that the IMS sublayer detects whether an IMS voice session that is being performed exists, where the first indication information is sent by the CC sublayer to the IMS sublayer after the CC sublayer triggers a first CS session for an originating call of the UE;
sending signaling to a network if the IMS sublayer detects that the IMS voice session that is being performed exists, where the signaling is used to trigger a hold procedure of the IMS voice session, so that the IMS voice session is in a hold state; and
after the UE completes establishment of a mobility management connection, establishing, by the CC sublayer according to second indication information sent by a mobility management (MM) sublayer in the UE, a second CS session corresponding to the INS voice session, where the second CS session is in a hold state.

In a first possible implementation manner of the first aspect, the establishing, by the CC sublayer according to second indication information sent by an MM sublayer, a second CS session corresponding to the IMS voice session includes:
establishing, by the CC sublayer, the second CS session according to the second indication information;
sending, by the CC sublayer, status obtaining information to the IMS sublayer, so as to obtain the status of the IMS voice session; and
receiving, by the CC sublayer, status obtaining response information sent by the IMS sublayer, obtaining, according to the status obtaining response information, that the IMS voice session is in the hold state, and correspondingly setting a status of the second CS session to the hold state.

In a second possible implementation manner of the first aspect, the establishing, by the CC sublayer according to second indication information sent by an MM sublayer, a second CS session corresponding to the IMS voice session includes:
establishing, by the CC sublayer, the second CS session according to the second indication information; and
setting, by the CC sublayer, a status of the second CS session to the hold state according to stored status obtaining response information, where the status obtaining response information indicates that the IMS voice session is in the hold state.

With reference to the first aspect or the second possible implementation manner of the first aspect, in a third possible implementation manner, the first indication information sent by the CC sublayer to the IMS sublayer further includes status obtaining information, and the status obtaining information is used to obtain the status of the IMS voice session; and
correspondingly, after the sending signaling to a network if the IMS sublayer detects that the IMS voice session that is being performed exists, where the signaling is used to trigger a hold procedure of the IMS voice session, so that the IMS voice session is in a hold state, before the establishing, by the CC sublayer, the second CS session according to the second indication information, the method further includes:
sending, by the IMS sublayer, the status obtaining response information to the CC sublayer, so that the CC sublayer stores the status obtaining response information.

With reference to the first aspect to the third possible implementation manner of the first aspect, in a fourth possible implementation manner, the completing, by the UE, establishment of a mobility management connection includes:
sending, by the CC sublayer, mobility management connection request signaling to the MM sublayer, where the mobility management connection request signaling is sent by the CC sublayer to the MM sublayer after the CC sublayer allocates the first CS session;
sending, by the MM sublayer, circuit switched fallback (CSFB) indication information to an evolved packet system mobility management (EMM) sublayer in the UE;
sending, by the EMM sublayer, a service expansion request to the network, so as to trigger a CSFB procedure, so that the network triggers a single radio voice call continuity (SRVCC) switching preparation procedure, where the CSFB procedure is used to fall back the UE from a first network to a second network and process the first CS session in the second network, and the SRVCC switching preparation procedure is used to prepare a corresponding resource for switching the IMS voice session from the first network to the second network;
receiving, by a second access sublayer in the UE, the resource that is sent by a first access sublayer in the UE and that is required for switching the IMS voice session from the first network to the second network, where the resource is obtained after the first access sublayer receives a switching command that is sent by the network and that includes the resource; and
completing, by the second access sublayer, establishment of the mobility management connection according to the resource.

With reference to the first aspect to the fourth possible implementation manner of the first aspect, in a fifth possible implementation manner, after the completing, by the second access sublayer, establishment of the mobility management connection according to the resource, the method further includes:
receiving, by the MM sublayer, access indication information sent by the second access sublayer, where the access indication information is used to indicate that the mobility management connection has been established;
sending, by the MM sublayer, third indication information to the CC sublayer, where the third indication information is used to indicate that the mobility management connection has been established; and
after receiving the third indication information, sending, by the CC sublayer, a connection management service request to the MM sublayer, so that the MM sublayer completes establishment of the first CS session.

With reference to the first aspect to the fifth possible implementation manner of the first aspect, in a sixth possible implementation manner, the first network is a Long Term Evolution LTE network; and the second network is a second generation/third generation (2G/3G) network.

With reference to the fourth possible implementation manner of the first aspect or the fifth possible implementation manner of the first aspect, in a seventh possible implementation manner, the first access sublayer is an evolved universal terrestrial radio access network (E-UTRAN) access sublayer; and

the second access sublayer is a global system for mobile communications/enhanced data rates for GSM evolution radio access network/universal terrestrial radio access network (GERAN/UTRAN) access sublayer.

According to a second aspect, an embodiment of the present invention provides user equipment, including:
a call control module, configured to send first indication information to an Internet protocol (IP) multimedia subsystem module, so that the IP multimedia subsystem module detects whether an IP multimedia subsystem (IMS) voice session that is being performed exists, where the first indication information is sent by the call control module to the IP multimedia subsystem module after the call control module triggers a first CS session for an originating call of the user equipment; and
the IP multimedia subsystem module, configured to send signaling to a network if it is detected that the IMS voice session that is being performed exists, where the signaling is used to trigger a hold procedure of the IMS voice session, so that the IMS voice session is in a hold state; where
the call control module is further configured to: after the user equipment completes establishment of a mobility management connection, establish, according to second indication information sent by a mobility management module, a second CS session corresponding to the IMS voice session, where the second CS session is in a hold state.

In a first possible implementation manner of the second aspect, the call control module is specifically configured to: establish the second CS session according to the second indication information; send status obtaining information to the IP multimedia subsystem module, so as to obtain the status of the IMS voice session; and receive status obtaining response information sent by the IP multimedia subsystem module, obtain, according to the status obtaining response information, that the IMS voice session is in the hold state, and correspondingly set a status of the second CS session to the hold state.

In a second possible implementation manner of the second aspect, the call control module is specifically configured to: establish the second CS session according to the second indication information; and set a status of the second CS session to the hold state according to stored status obtaining response information, where the status obtaining response information indicates that the IMS voice session is in the hold state.

With reference to the second aspect or the second possible implementation manner of the second aspect, in a third possible implementation manner, the first indication information sent by the call control module to the IP multimedia subsystem module further includes status obtaining information, and the status obtaining information is used to obtain the status of the IMS voice session; and
correspondingly, the IP multimedia subsystem module is further configured to send the status obtaining response information to the call control module, so that the call control module stores the status obtaining response information.

With reference to the second aspect to the third possible implementation manner of the second aspect, in a fourth possible implementation manner, the call control module is specifically configured to send mobility management connection request signaling to the mobility management module, where the mobility management connection request signaling is sent by the call control module to the mobility management module after the call control module allocates the first CS session;
the user equipment further includes an evolved packet system mobility management module, and the mobility management module is specifically configured to send circuit switched fallback (CSFB) indication information to the evolved packet system mobility management module;
the evolved packet system mobility management module is configured to send a service expansion request to the network, so as to trigger a CSFB procedure, so that the network triggers a single radio voice call continuity (SRVCC) switching preparation procedure, where the CSFB procedure is used to fall back the user equipment from a first network to a second network and process the first CS session in the second network, and the SRVCC switching preparation procedure is used to prepare a corresponding resource for switching the IMS voice session from the first network to the second network; and
the user equipment further includes a second access sublayer module, configured to: receive the resource that is sent by a first access sublayer module and that is required for switching the IMS voice session from the first network to the second network, where the resource is obtained after the first access sublayer module receives a switching command that is sent by the network and that includes the resource; and complete establishment of the mobility management connection according to the resource.

With reference to the second aspect to the fourth possible implementation manner of the second aspect, in a fifth possible implementation manner, the mobility management module is further configured to: receive access indication information sent by the second access sublayer module, where the access indication information is used to indicate that the mobility management connection has been established; and send third indication information to the call control module, where the third indication information is used to indicate that the mobility management connection has been established; and
the call control module is further configured to: after receiving the third indication information, send a connection management service request to the mobility management module, so that the mobility management module completes establishment of the first CS session.

With reference to the second aspect to the fifth possible implementation manner of the second aspect, in a sixth possible implementation manner, the first network is a Long Term Evolution LTE network; and the second network is a second generation/third generation (2G/3G) network.

With reference to the fourth possible implementation manner of the second aspect or the fifth possible implementation manner of the second aspect, in a seventh possible implementation manner, the first access sublayer module is an evolved universal terrestrial radio access network (E-UTRAN) access sublayer module; and
the second access sublayer module is a global system for mobile communications/enhanced data rates for GSM evolution radio access network/universal terrestrial radio access network (GERAN/UTRAN) access sublayer module.

According to the call hold method and the user equipment in the embodiments of the present invention, when UE triggers a CS voice service, first indication information is sent to an IMS sublayer by using a CC sublayer, so that the IMS sublayer detects whether an IMS voice session exists; signaling is sent to a network if the IMS sublayer detects that the IMS voice session that is not in a hold state (for example, that is being performed) exists, where the signaling is used to trigger a hold procedure of the IMS voice session, so that the IMS voice session is in a hold state; and after the UE completes establishment of a mobility management connection, the CC sublayer establishes, according to second indication information sent by an MM sublayer in the UE, a second CS session corresponding to the IMS voice session, where the second CS session is in a hold state, so that after the corresponding second CS session is established for the IMS voice session on which SRVCC switching is performed, the status of the second CS session may be set to the hold state, thereby avoiding occurrence of a case of session abnormality.

### BRIEF DESCRIPTION OF THE DRAWINGS

To describe the technical solutions in the embodiments of the present invention more clearly, the following briefly describes the accompanying drawings required for describing the embodiments or the prior art. Apparently, the accompanying drawings in the following description show some embodiments of the present invention, and persons of ordinary skill in the art may still derive other drawings from these accompanying drawings without creative efforts.

FIG. 1 is a flowchart of Embodiment 1 of a call hold method according to the present invention;

FIG. 2 is a flowchart of Embodiment 2 of a call hold method according to the present invention;

FIG. 3 is a flowchart of Embodiment 3 of a call hold method according to the present invention;

FIG. 4 is a flowchart of establishment of a mobility management connection in a call hold method according to the present invention; and

FIG. 5 is a schematic structural diagram of Embodiment 1 of user equipment according to the present invention.

### DETAILED DESCRIPTION

To make the objectives, technical solutions, and advantages of the embodiments of the present invention clearer, the following clearly describes the technical solutions in the embodiments of the present invention with reference to the accompanying drawings in the embodiments of the present invention. Apparently, the described embodiments are some but not all of the embodiments of the present invention. All other embodiments obtained by persons of ordinary skill in the art based on the embodiments of the present invention without creative efforts shall fall within the protection scope of the present invention.

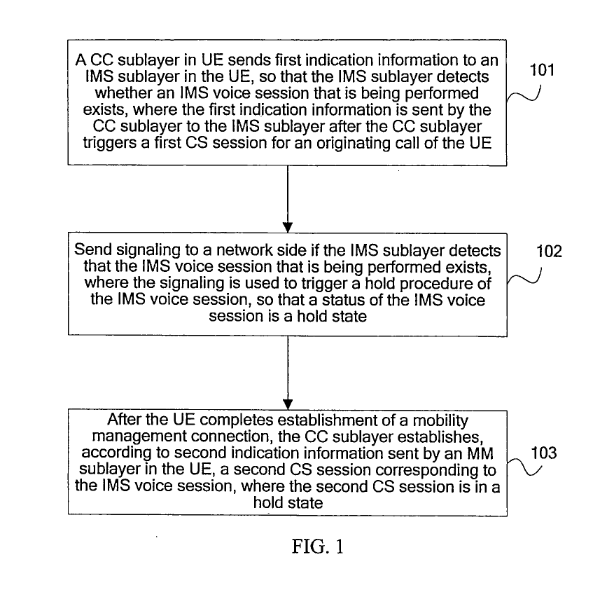

FIG. 1 is a flowchart of Embodiment 1 of a call hold method according to the present invention. As shown in FIG. 1, the call hold method provided in this embodiment may be specifically performed by user equipment (UE), and the method provided in this embodiment may include:

S101: A CC sublayer in UE sends first indication information to an IMS sublayer in the UE, so that the IMS sublayer detects whether an IMS voice session that is being performed exists, where the first indication information is sent by the CC sublayer to the IMS sublayer after the CC sublayer triggers a first CS session for an originating call of the UE.

Specifically, when the originating call of the UE triggers a CS voice service, for example, an emergency call, the CC sublayer in a connection management (CM) protocol sublayer in the UE receives dialing information from an upper layer, where the dialing information is used to instruct the CC sublayer to allocate the first CS session to the CS voice service, for example, to allocate a session whose transaction identifier (TI) is 0 and whose TI flag bit is 0 to the CS voice service. After receiving the foregoing dialing information, the CC sublayer allocates the first CS session to the CS voice service according to the dialing information, and after allocating the first CS session, sends the first indication information to the IMS sublayer.

After receiving the first indication information sent by the CC sublayer, the INS sublayer learns that the CC sublayer initiates a CS voice service, and the INS sublayer detects whether the INS voice session exists. Specifically, the IMS sublayer detects whether the INS voice session that is being performed exists, and if the INS voice session that is being performed exists, triggers a hold procedure of the session.

S102: Send signaling to a network if the IMS sublayer detects that the IMS voice session that is being performed exists, where the signaling is used to trigger a hold procedure of the INS voice session, so that the IMS voice session is in a hold state.

Specifically, after the INS sublayer triggers the hold procedure of the INS voice session by using the signaling, the status of the IMS voice session is converted to the hold state, that is, before the hold procedure is triggered, the status of the IMS voice session may be a conversation state, a ringing state, or the like; and after the hold procedure is triggered, the status of the IMS voice session is converted from the conversation state, the ringing state, or the like to the hold state.

S103: After the UE completes establishment of a mobility management connection, the CC sublayer establishes, according to second indication information sent by an MM sublayer in the UE, a second CS session corresponding to the IMS voice session, where the second CS session is in a hold state.

In this step, after the second CS session corresponding to the IMS voice session is established, the UE also sets a status of the second CS session to the hold state according to the obtained state of the IMS voice session, that is, the hold state, so that a second CS session, corresponding to the IMS voice session, in a 2G/3G network is set to the hold state. The CS voice service triggered by the originating call of the UE can be normally performed, thereby avoiding occurrence of a case of session abnormality.

According to the technical solution in this embodiment, when UE triggers a CS voice service, first indication information is sent to an IMS sublayer by using a CC sublayer, so that the IMS sublayer detects whether an IMS voice session exists; signaling is sent to a network if the IMS sublayer detects that the IMS voice session that is not in a hold state (for example, that is being performed) exists, where the signaling is used to trigger a hold procedure of the IMS voice session, so that the IMS voice session is in a hold state; and after the UE completes establishment of a mobility management connection, the CC sublayer establishes, according to second indication information sent by an MM sublayer in the UE, a second CS session corresponding to the IMS voice session, and sets a status of the second CS session according to the obtained state of the IMS voice session, where the status of the second CS session is the hold state, so that after the corresponding second CS session is established for the IMS voice session on which SRVCC switching is performed, the status of the second CS session may be set to the hold state, thereby avoiding occurrence of a case of session abnormality.

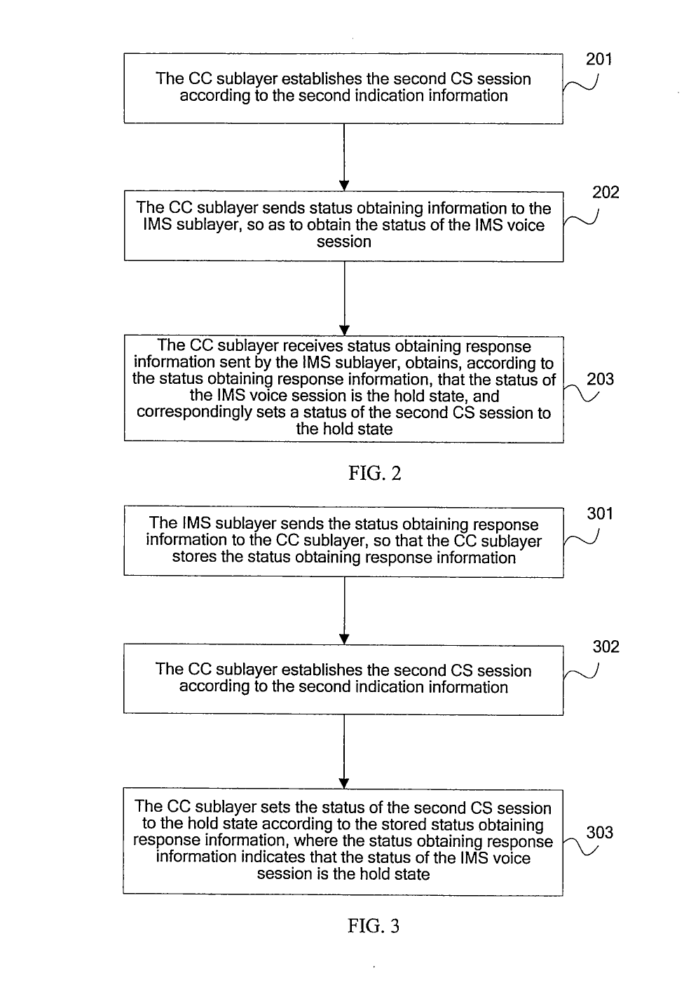

FIG. 2 is a flowchart of Embodiment 2 of a call hold method according to the present invention. As shown in FIG. 2, based on the foregoing embodiment, after the UE completes the establishment of the mobility management connection, in the method provided in this embodiment, the foregoing S103 may include:

S201: The CC sublayer establishes the second CS session according to the second indication information.

Specifically, the second CS session corresponds to the IMS voice session on which the SRVCC switching is performed, and the status of the second CS session is the same as the status of the IMS voice session. In this step, the second CS session, for example, may be a session whose TI is 0 and whose TI flag bit is 1, and is different

S202: The CC sublayer sends status obtaining information to the IMS sublayer, so as to obtain the status of the IMS voice session.

S203: The CC sublayer receives status obtaining response information sent by the IMS sublayer, obtains, according to the status obtaining response information, that the IMS voice session is in the hold state, and correspondingly sets a status of the second CS session to the hold state.

Specifically, after the UE completes the establishment of the mobility management connection, the CC sublayer learns, by communicating with the IMS sublayer again, that the IMS voice session is in the hold state, and correspondingly sets the status of the second CS session corresponding to the IMS voice session before the switching to the hold state. Therefore, the second CS session obtained by means of switching of the IMS voice session in an original first network is set to the hold state in a second network. The CS voice service triggered by the originating call of the UE, that is, the first CS session, can be normally performed. The first network may be an LTE network, and the second network may be a 2G/3G network.

According to the technical solution in this embodiment, when an originating call of UE triggers a CS voice service, an IMS voice session that originally exists and that is being performed is held on an LTE side, a second CS session corresponding to the original IMS voice session is established in a 2G/3G network after SRVCC switching, and a status of the second CS session is set to a hold state; and a newly-initiated calling CS voice service, that is, a first CS session, is normally performed, thereby avoiding occurrence of a case of session abnormality.

FIG. 3 is a flowchart of Embodiment 3 of a call hold method according to the present invention. As shown in FIG. 3, based on the foregoing embodiments, in the method provided in this embodiment, in the foregoing S101, the first indication information sent by the CC sublayer to the IMS sublayer may further include status obtaining information, and the status obtaining information is used to obtain the status of the IMS voice session.

Correspondingly, after the foregoing S102, the method provided in this embodiment may further include:

S301: The IMS sublayer sends the status obtaining response information to the CC sublayer, so that the CC sublayer stores the status obtaining response information.

It should be noted that in this embodiment, when the originating call of the UE triggers the CS voice service, for example, an emergency call, after allocating the first CS session to the CS voice service according to the dialing information, the CC sublayer may send the first indication information including the status obtaining information to the IMS sublayer, so that the IMS sublayer detects whether the IMS voice session that is being performed exists. If the IMS sublayer detects that an IMS voice session that is not in a hold state, for example, the IMS voice session that is being performed, exists, the IMS sublayer sends the signaling to the network, so as to trigger the hold procedure of the session. Then, the IMS sublayer sends the status obtaining response information to the CC sublayer, where the status obtaining response information indicates that the IMS voice session is in the hold state. After receiving the status obtaining response information, the CC sublayer stores the status obtaining response information.

Correspondingly, after S301, in the method provided in this embodiment, the foregoing S103 may include:

S302: The CC sublayer establishes the second CS session according to the second indication information.

S303: The CC sublayer sets the status of the second CS session to the hold state according to the stored status obtaining response information, where the status obtaining response information indicates that the IMS voice session is in the hold state.

Because in S301, the CC sublayer stores the status obtaining response information, in this step, the CC sublayer may directly correspondingly set the status of the second CS session to the hold state according to the stored status obtaining response information.

According to the technical solution in this embodiment, when an originating call of UE triggers a CS voice service, an IMS voice session that originally exists and that is being performed is held on an LTE side, a second CS session corresponding to the original IMS voice session is established in a 2G/3G network after SRVCC switching, and a status of the second CS session is set to a hold state; and a newly-initiated calling CS voice service, that is, a first CS session, is normally performed, thereby avoiding occurrence of a case of session abnormality.

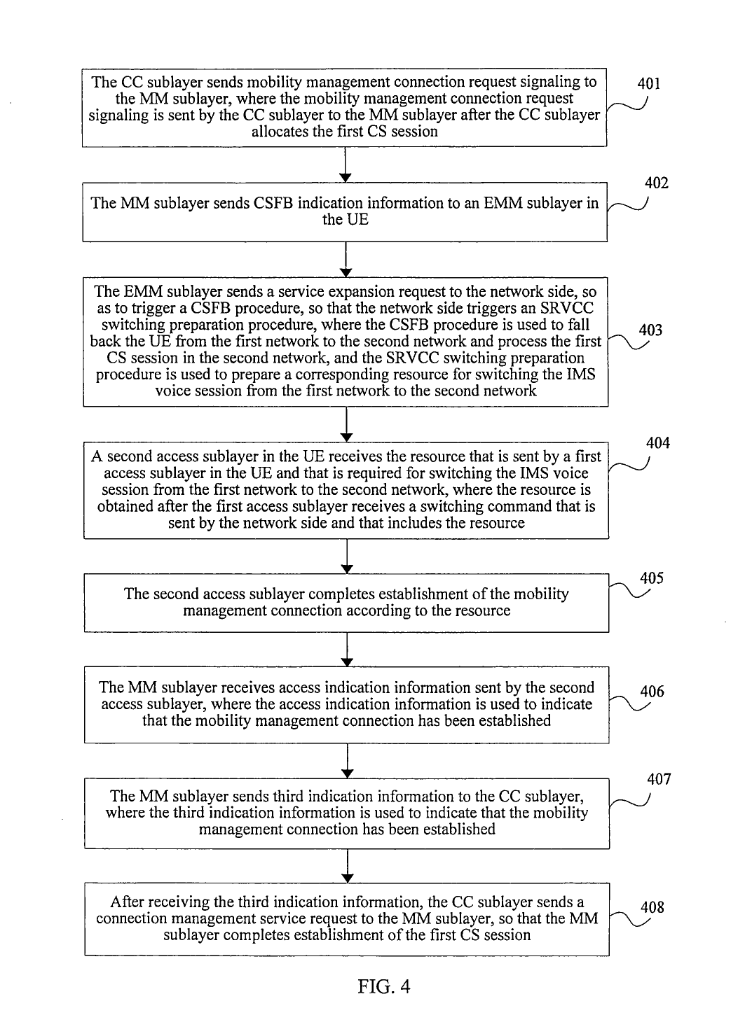

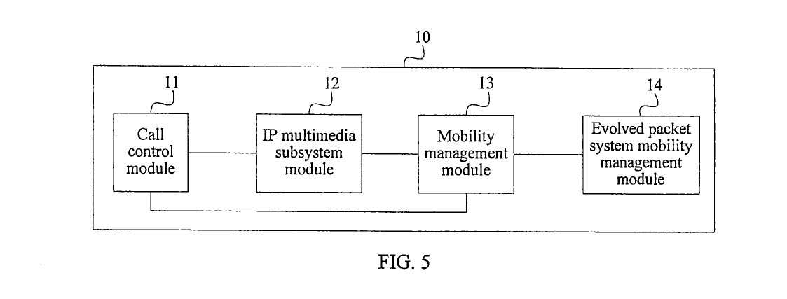

FIG. 4 is a flowchart of establishment of a mobility management connection in a call hold method according to the present invention. As shown in FIG. 4, based on the foregoing embodiments, in the foregoing S103, the completing, by the UE, establishment of a mobility management connection may specifically include:

S401: The CC sublayer sends mobility management connection request signaling to the MM sublayer, where the mobility management connection request signaling is sent by the CC sublayer to the MM sublayer after the CC sublayer allocates the first CS session.

S402: The MM sublayer sends CSFB indication information to an EMM sublayer in the UE.

S403: The EMM sublayer sends a service expansion request to the network, so as to trigger a CSFB procedure, so that the network triggers an SRVCC switching preparation procedure, where the CSFB procedure is used to fall back the UE from the first network to the second network and process the first CS session in the second network, and the SRVCC switching preparation procedure is used to prepare a corresponding resource for switching the IMS voice session from the first network to the second network.

In this step, after receiving the CSFB indication information, the EMM sublayer sends a service expansion request command to the network, so as to trigger the CSFB procedure, where the CSFB procedure is used to fall back the UE from the first network to the second network and process the first CS session in the second network. On the other hand, the network triggers the SRVCC switching preparation procedure, where the SRVCC switching preparation procedure is used to prepare the corresponding resource for switching the IMS session of the UE from the first network to the second network, and the corresponding resource required for switching the IMS session from the first network to the second network may include a CS resource. If the SRVCC switching preparation procedure both supports PS switching and dual transfer mode switching, the resource may further include a PS resource. Specifically, the first network may be an LTE network, and the second network may be a 2G/3G network.

S404: A second access sublayer in the UE receives the resource that is sent by a first access sublayer in the UE and that is required for switching the IMS voice session from the first network to the second network, where the resource is obtained after the first access sublayer receives a switching command that is sent by the network and that includes the resource.

Specifically, the first access sublayer may be an evolved universal terrestrial radio access network (E-UTRAN) access sublayer; the second access sublayer may be a Global System for Mobile communications/Enhanced Data rates for (GSM) Evolution radio access network/universal terrestrial radio access network (GERAN/UTRAN) access sublayer.

S405: The second access sublayer completes establishment of the mobility management connection according to the resource.

Correspondingly, after the UE completes the establishment of a mobility management connection, the method may further include:

S406: The MM sublayer receives access indication information sent by the second access sublayer, where the access indication information is used to indicate that the mobility management connection has been established.

S407: The MM sublayer sends third indication information to the CC sublayer, where the third indication information is used to indicate that the mobility management connection has been established.

S408: After receiving the third indication information, the CC sublayer sends a connection management service request to the MM sublayer, so that the MM sublayer completes establishment of the first CS session.

It should be noted that the second indication information and the third indication information do not represent a time sequence, and are merely used to distinguish differences between the second indication information and the third indication information. The third indication information is used to indicate that the mobility management connection has been established; and the second indication information is used to indicate that the CC sublayer establishes the second CS session, where the second CS session is obtained after the IMS voice session is switched from the first network to the second network.

According to the technical solution in this embodiment, when an originating call of UE triggers a CS voice service, an IMS voice session that originally exists and that is being performed is held on an LTE side, after establishment of a mobility management connection is completed after SRVCC switching, a second CS session corresponding to the original IMS voice session is established in a 2G/3G network, and a status of the second CS session is set to a hold state; and a newly-initiated calling CS voice service, that is, a first CS session, is normally performed, thereby avoiding occurrence of a case of session abnormality.

FIG. 5 is a schematic structural diagram of Embodiment 1 of user equipment 10 according to the present invention. As shown in FIG. 5, the user equipment 10 provided in this embodiment may specifically include: a call control module 11, an IP multimedia subsystem module 12, and a mobility management module 13.

The call control module 11 may be configured to send first indication information to the IP multimedia subsystem module 12, so that the IP multimedia subsystem module 12 detects whether an IP multimedia subsystem (IMS) voice session that is being performed exists, where the first indication information is sent by the call control module 11 to the IP multimedia subsystem module 12 after an originating call of the user equipment 10 triggers a first CS session.

The IP multimedia subsystem module 12 may be configured to send signaling to a network if it is detected that the IMS voice session that is being performed exists, where the signaling is used to trigger a hold procedure of the IMS voice session, so that the IMS voice session is in a hold state.

The call control module 11 may be further configured to: after the user equipment 10 completes establishment of a mobility management connection, establish, according to second indication information sent by the mobility management module 13, a second CS session corresponding to the IMS voice session, where the second CS session is in a hold state.

In a feasible implementation manner, the call control module 11 is specifically configured to: establish the second CS session according to the second indication information; send status obtaining information to the IP multimedia subsystem module 12, so as to obtain the status of the IMS voice session; and receive status obtaining response information sent by the IP multimedia subsystem module 12, obtain, according to the status obtaining response information, that the IMS voice session is in the hold state, and correspondingly set a status of the second CS session to the hold state.

In another feasible implementation manner, the call control module 11 is specifically configured to: establish the second CS session according to the second indication information; and set a status of the second CS session to the hold state according to the stored status obtaining response information, where the status obtaining response information indicates that the IMS voice session is in the hold state.

Further, the first indication information sent by the call control module 11 to the IP multimedia subsystem module 12 further includes status obtaining information, and the status obtaining information is used to obtain the status of the IMS voice session. Correspondingly, the IP multimedia subsystem module 12 maybe further configured to send the status obtaining response information to the call control module 11, so that the call control module 11 stores the status obtaining response information.

Specifically, the call control module 11 may be specifically configured to send mobility management connection request signaling to the mobility management module 13, where the mobility management connection request signaling is sent by the call control module 11 to the mobility management module 13 after the call control module 11 allocates the first CS session.

The user equipment 10 may further include an evolved packet system mobility management module 14, and the mobility management module 13 may be specifically configured to send CSFB indication information to the evolved packet system mobility management module 14. The evolved packet system mobility management module 14 is configured to send a service expansion request to the network, so as to trigger a CSFB procedure, so that the network triggers an SRVCC switching preparation procedure, where the CSFB procedure is used to fall back the user equipment 10 from a first network to a second network and process the first CS session in the second network, and the SRVCC switching preparation procedure is used to prepare a corresponding resource for switching the IMS voice session from the first network to the second network. The user equipment 10 may further include a second access sublayer module, configured to: receive the resource that is sent by a first access sublayer module and that is required for switching the IMS voice session from the first network to the second network, where the resource is obtained after the first access sublayer module receives a switching command that is sent by the network and that includes the resource; and complete establishment of the mobility management connection according to the resource.

Further, the mobility management module 13 may be further configured to: receive access indication information sent by the second access sublayer module, where the access indication information is used to indicate that the mobility management connection has been established; and send the third indication information to the call control module 11, where the third indication information is used to indicate that the mobility management connection has been established. The call control module 11 may be further configured to: after receiving the third indication information, send a connection management service request to the mobility management module 13, so that the mobility management module 13 completes establishment of the first CS session.

It should be noted that the first network is an LTE network; the second network is a 2G/3G network; the first access sublayer module is an evolved universal terrestrial radio access network (E-UTRAN) access sublayer module; and the second access sublayer module is a GERAN/UTRAN access sublayer module.

The user equipment in this embodiment may be configured to perform the technical solutions in the foregoing method embodiments, and the implementation principles and technical effects thereof are similar, which are not described in detail herein again.

In the several embodiments provided in the present invention, it should be understood that the disclosed apparatus and method may be implemented in other manners. For example, the described apparatus embodiment is merely exemplary. For example, the unit division is merely logical function division and may be other division in actual implementation. For example, a plurality of units or components may be combined or integrated into another system, or some features may be ignored or not performed. In addition, the displayed or discussed mutual couplings or direct couplings or communication connections may be implemented by using some interfaces. The indirect couplings or communication connections between the apparatuses or units may be implemented in electronic, mechanical, or other thins.

The units described as separate parts may or may not be physically separate, and parts displayed as units may or may not be physical units, may be located in one position, or may be distributed on a plurality of network units. Some or all of the units may be selected according to actual needs to achieve the objectives of the solutions of the embodiments.

In addition, functional units in the embodiments of the present invention may be integrated into one processing unit, or each of the units may exist alone physically, or two or more units are integrated into one unit. The integrated unit may be implemented in a form of hardware, or may be implemented in a form of hardware in addition to a software functional unit.

When the foregoing integrated unit is implemented in a form of a software functional unit, the integrated unit may be stored in a computer-readable storage medium. The software functional unit is stored in a storage medium and includes several instructions for instructing a computer device (which may be a personal computer, a server, a network device, or the like) or a processor (processor) to perform some of the steps of the methods described in the embodiments of the present invention. The foregoing storage medium includes: any medium that can store program code, such as a USB flash drive, a removable hard disk, a read-only memory (ROM), a random access memory (RAM), a magnetic disk, or an optical disc.

It may be clearly understood by persons skilled in the art that, for the purpose of convenient and brief description, division of the foregoing functional modules is taken as an example for illustration. In actual application, the foregoing functions can be allocated to different functional modules and implemented according to a requirement, that is, an inner structure of an apparatus is divided into different functional modules to implement all or some of the functions described above. For a detailed working process of the foregoing apparatus, reference may be made to a corresponding process in the foregoing method embodiments, and details are not described herein again.

Finally, it should be noted that the foregoing embodiments are merely intended for describing the technical solutions of the present invention, but not for limiting the present invention. Although the present invention is described in detail with reference to the foregoing embodiments, persons of ordinary skill in the art should understand that they may still make modifications to the technical solutions described in the foregoing embodiments or make equivalent replacements to some or all technical features thereof, without departing from the scope of the technical solutions of the embodiments of the present invention.

What is claimed is:

1. A call hold method, comprising:
sending, by a call control (CC) sublayer in a terminal, first indication information to an internet protocol IP multimedia subsystem (IMS) sublayer in the terminal, so that the IMS sublayer detects whether an IMS voice session that is being performed exists, wherein the first indication information is sent by the CC sublayer to the IMS sublayer after the CC sublayer triggers a first circuit switched (CS) session for an originating call of the terminal;
sending signaling to a network when the IMS sublayer detects that the IMS voice session that is being performed exists, wherein the signaling is used to trigger a hold procedure of the IMS voice session, so that the IMS voice session is in a hold state; and
after the terminal completes establishment of a mobility management connection, establishing, by the CC sublayer according to second indication information sent by a mobility management (MM) sublayer in the terminal, a second CS session corresponding to the IMS voice session, wherein the second CS session is in a hold state.

2. The method according to claim 1, wherein establishing the second CS session corresponding to the IMS voice session further comprises:
establishing, by the CC sublayer, the second CS session according to the second indication information;
sending, by the CC sublayer, status obtaining information to the IMS sublayer, so as to obtain the status of the IMS voice session;
receiving, by the CC sublayer, status obtaining response information sent by the IMS sublayer; and
obtaining, according to the status obtaining response information, that the IMS voice session is in the hold state, and correspondingly setting a status of the second CS session to the hold state.

3. The method according to claim 1, wherein establishing the second CS session corresponding to the IMS voice session further comprises:
establishing, by the CC sublayer, the second CS session according to the second indication information; and
setting, by the CC sublayer, a status of the second CS session to the hold state according to stored status obtaining response information, wherein the status obtaining response information indicates that the IMS voice session is in the hold state.

4. The method according to claim 1, wherein the first indication information further comprises status obtaining information, and the status obtaining information is used to obtain the status of the IMS voice session; and
correspondingly, after sending the signaling to the network when the IMS sublayer detects that the IMS voice session that is being performed exists, and before establishing the second CS session according to the second indication information, the method further comprises:
sending, by the IMS sublayer, the status obtaining response information to the CC sublayer, so that the CC sublayer stores the status obtaining response information.

5. The method according to claim 1, wherein completing, by the terminal, the establishment of the mobility management connection further comprises:
sending, by the CC sublayer, mobility management connection request signaling to the MM sublayer, wherein the mobility management connection request signaling is sent by the CC sublayer to the MM sublayer after the CC sublayer allocates the first CS session;
sending, by the MM sublayer, circuit switched fallback (CSFB) indication information to an evolved packet system mobility management (EMM) sublayer in the terminal;
sending, by the EMM sublayer, a service expansion request to the network, so as to trigger a CSFB procedure, so that the network triggers a single radio voice call continuity (SRVCC) switching preparation procedure, wherein the CSFB procedure is used to fall back the terminal from a first network to a second network and process the first CS session in the second network, and the SRVCC switching preparation procedure is used to prepare a corresponding resource for switching the IMS voice session from the first network to the second network;
receiving, by a second access sublayer in the terminal, the resource that is sent by a first access sublayer in the terminal and that is required for switching the IMS voice session from the first network to the second network, wherein the resource is obtained after the first access sublayer receives a switching command that is sent by the network and that comprises the resource; and
completing, by the second access sublayer, establishment of the mobility management connection according to the resource.

6. The method according to claim 1, after completing, by the second access sublayer, establishment of the mobility management connection according to the resource, further comprising:
receiving, by the MM sublayer, access indication information sent by the second access sublayer, wherein the access indication information is used to indicate that the mobility management connection has been established;
sending, by the MM sublayer, third indication information to the CC sublayer, wherein the third indication information is used to indicate that the mobility management connection has been established; and
after receiving the third indication information, sending, by the CC sublayer, a connection management service request to the MM sublayer, so that the MM sublayer completes establishment of the first CS session.

7. The method according to claim 1, wherein
the first network is a Long Term Evolution (LTE) network; and
the second network is a second generation/third generation (2G/3G) network.

8. The method according to claim 5, wherein
the first access sublayer is an evolved universal terrestrial radio access network (E-UTRAN) access sublayer; and
the second access sublayer is a global system for mobile communications/enhanced data rates for GSM evolution radio access network/universal terrestrial radio access network (GERAN/UTRAN) access sublayer.

9. A terminal, comprising:
a transmitter, configured to send first indication information after a first circuit switched (CS) session for an originating call of the terminal is triggered;
a receiver, configured to receive the first indication information; and
a processor, configured to detect whether an IP multimedia subsystem (IMS) voice session that is being performed exists according to the first indication information; wherein
the transmitter is further configured to send signaling to a network when it is detected that the IMS voice session that is being performed exists, wherein the signaling is used to trigger a hold procedure of the IMS voice session, so that the IMS voice session is in a hold state; wherein
the processor is further configured to:
after the terminal completes establishment of a mobility management connection, establish, according to second indication information sent by the transmitter, a second CS session corresponding to the IMS voice session, wherein the second CS session is in a hold state.

10. The terminal according to claim 9, wherein
the processor is further configured to establish the second CS session according to the second indication information;
the transmitter is further configured to send status obtaining information to the processor, so as to obtain the status of the IMS voice session; and
the receiver is further configured to receive status obtaining response information sent by the transmitter;
wherein the processor is further configured to obtain, according to the status obtaining response information, that the IMS voice session is in the hold state, and correspondingly set a status of the second CS session to the hold state.

11. The terminal according to claim 9, wherein the processor is further configured to:
establish the second CS session according to the second indication information; and
set a status of the second CS session to the hold state according to stored status obtaining response information, wherein the status obtaining response information indicates that the IMS voice session is in the hold state.

12. The terminal according to claim 9, wherein the first indication information further comprises status obtaining information, and the status obtaining information is used to obtain the status of the IMS voice session; and
correspondingly, the transmitter is further configured to send the status obtaining response information to the processor, so that the processor stores the status obtaining response information.

13. The terminal according to claim 9, wherein the transmitter is further configured to:
send mobility management connection request signaling after the processor allocates the first CS session;
send circuit switched fallback (CSFB) indication information; and
send a service expansion request to the network, so as to trigger a CSFB procedure, so that the network triggers a single radio voice call continuity (SRVCC) switching preparation procedure, wherein the CSFB procedure is used to fallback the terminal from a first network to a second network and process the first CS session in the second network, and the SRVCC switching preparation procedure is used to prepare a corresponding resource for switching the IMS voice session from the first network to the second network;
the user equipment further comprises a second access sublayer processor, configured to receive the resource that is sent by a first access sublayer processor and that is required for switching the IMS voice session from the first network to the second network; and
the processor is further configured to:
obtain the resource after the first access sublayer processor receives a switching command that is sent by the network and that comprises the resource; and
complete establishment of the mobility management connection according to the resource.

14. The terminal according to claim 9, wherein the receiver is further configured to:
receive access indication information, wherein the access indication information is used to indicate that the mobility management connection has been established; and
the transmitter is further configured to
send third indication information, wherein the third indication information is used to indicate that the mobility management connection has been established; and after the receiver receives the third indication information, send a connection management service request to the processor, so that the processor completes establishment of the first CS session.

15. The terminal according to claim 9, wherein
the first network is a Long Term Evolution LTE network; and
the second network is a second generation/third generation (2G/3G) network.

16. The terminal according to claim 13, wherein
the first access sublayer processor is an evolved universal terrestrial radio access network (E-UTRAN) access sublayer processor; and
the second access sublayer processor is a global system for mobile communications/enhanced data rates for GSM evolution radio access network/universal terrestrial radio access network (GERAN/UTRAN) access sublayer processor.
